(19) United States
(12) Patent Application Publication
(10) Pub. No.: US 2011/0139812 A1
(43) Pub. Date: Jun. 16, 2011

(54) Method For Dosing And Providing Powder In A Powder Provider, Such A Powder Provider Device And An Apparatus For Producing Packs

(76) Inventor: Allan Dagsland, Lund (SE)

(21) Appl. No.: 12/674,859

(22) PCT Filed: Aug. 22, 2008
(86) PCT No.: PCT/SE08/50945

§ 371 Date: Mar. 3, 2011

Related U.S. Application Data
(60) Provisional application No. 60/957,822, filed on Aug. 24, 2007.

(51) Int. Cl. B67D 7/06

(52) U.S. Cl. 222/1; 222/92

(57) ABSTRACT

Disclosed is a powder provider device that comprises, a powder hopper for pouring powder batches to a dosing system that comprises a hole structure, wherein at least one hole is formed by a surrounding wall structure. The wall structure is formed by wall portions that are movable relative to one another, whereby the relative movement of wall portions, during handling of the powder, enables controlled dosing and pouring of the powder. Also disclosed is an apparatus comprising said powder providing device and a method of dosing and providing powder in a powder provider device.

### FIELD OF THE INVENTION

The invention relates to a powder provider device that comprises, a powder hopper for pouring powder batches to a dosing system that comprises a hole structure, wherein at least one hole is formed by a surrounding wall structure. Moreover, the invention relates to a method of dosing and providing powder in a powder provider device.

### BACKGROUND OF THE INVENTION

Today, supply and distribution of medicament is accomplished in many different ways. Within health care more and more effort is focused on the possibility to dose and distribute medicaments in the form of powder directly to the lungs of a user by means of a dispensing device, for example an inhalation device, to obtain an efficient and user-friendly administration of the specific medicament. In some cases, some form of dosing process is used for preparing the dose to be inhaled. The doses of medicament may be provided in packs having several cavities for housing a dose of medicament. The cavities filled with a dose are subsequently sealed by a sealing sheet, for example a foil of aluminum. These packs are loaded into a dispensing device, in which the foil above the cavity is penetrated and the dose of medicament is released for inhalation by the user. By this sealing, the medicament is well protected before inhalation.

There are also other cases where it is suitable to provide doses of medicament in packs having cavities for housing a dose of medicament, which cavities are sealed by a foil. The packs containing the doses of medicament can be in the form of blister packs or injection molded disks provided with blisters and cavities, respectively, for housing the powdered medicament. The packs can have various shapes, and the cavities can be distributed in various patterns. The method for filling said cavities must provide an accurate and changeable dosing into the cavities. This is to ensure that the packs contain accurate doses of medicament of different sizes.

EP 1 354 795 A2 discloses a method and apparatus for the metered transport of fine powders into receptacles. The apparatus is provided with a hopper having an opening. The hopper is adapted to receive fine powder. Further, the apparatus comprises a vibrating element vibrating within the powder, and a rotatable member provided with a plurality of chambers aligned about its periphery. The rotatable member may be rotated to align the chambers with said opening to allow powder to be transferred from the hopper and into the chambers. The rotatable member is rotated 180° to a dispensing position where the chambers are aligned with said receptacles, and the receptacles are filled with the powder.

U.S. Pat. No. 5,187,921 A describes a method and apparatus for filling a blind cavity with a quantity of powder, which comprises urging the cavity, with its open side facing a least partially downwards, into a reservoir of powder, withdrawing from the cavity having the quantity of powder therein while the open side continues to face at least partially downwards, and subsequently applying a lid to cover the cavity having the powder therein.

WO 03/066437 A1 discloses a method and apparatus for introducing powder into a pocket having an open side, including orientating the pocket with the open side facing at least partially upward, providing the pocket with a volume of powder greater than that of the pocket, compressing the volume of the powder to a predetermined bulk density, and removing excess powder so as to leave the pocket full of powder with the predetermined bulk density.

U.S. Pat. No. 6,035,905 A describes a method for introducing each of a plurality of doses of particulate material into a respective compartment of a container, the method comprising the steps of inserting a respective projection, preferably a conduit through which said particle material is introduced into said compartment, into each compartment so as to reduce the capacity thereof, and filling each compartment with said particulate material, with the respective projection inserted in said compartment, and removing said projection, wherein the volume of each dose of material is less than that of its respective compartment.

However, above-mentioned solutions have several drawbacks. Some of above-mentioned methods and apparatuses cannot distribute with sufficient accuracy a specified dose of powder having a small particulate average size.

Medical applications relating to inhalable medicaments may involve the handling of very fine, low-density powders. It is sometimes experienced that these powders are difficult to handle due to their tendency to aerosolize, or become airborne, at the slightest affection. Mechanical powder providers, which rely only on mechanical members and gravity to apportion a particular, dose of powder from a larger supply thereof my lead to inaccurate doses.

There is a need in the art for an improved method and apparatus for filling containers with a precise dosage of powder. Specifically, what is needed is a method and a powder providing device. Furthermore, it is desirable to deliver a precisely metered dose of dry powder medicament to a capsule. Preferably, such a device would further be simple in design and easy to use, through either manual or computer controlled operation. The device would also be adapted to handle the low-density fine powders often present in medical applications, and to pack such powders into relatively small and precise doses for delivery to a cavity, using a small priming volume.

EP0806197B1 discloses a capsule filling device which comprises a base plate arranged between the dosage plate and the capsule plate, the base plate defining at least one funnel shaped channel having dimensions that permit a substance to be passed there through. Hence, the channel is aligned with the capsule holder means in the capsule plate and at least the channel in the upper housing is funnel shaped.

The object of the present invention is to provide a method and a device for filling at least one cavity with a quantity of particulate material, which can be portioned into cavities arranged in any kind of pattern in a pack or disk, for example arbitrary and non-linear patterns.

It is particularly an object of the present invention to repeatedly distribute an accurate dose of powder. It is desirable to enable a flexible and easy method for providing powder to new patterns of cavities, and simultaneously full multiple cavities or blisters in a cavity structure such as disc or pack, thereby providing a high production capacity. Furthermore, it is desirable that it is uncomplicated to full and manage cavities with particulate material to a low cost. Moreover, it is important that powder retention is kept at a minimum during pouring powder into a cavity and during handling of powder during the steps of measuring and filling etc.

### SUMMARY OF THE INVENTION

The above-mentioned object is achieved by providing a powder providing device of the kind defined in the preamble of claim 1, characterized in that said wall structure is formed by wall portions that are movable relative to one another, whereby the relative movement of wall portions, during handling of the powder, enables controlled dosing and pouring of the powder. The dosing system has at least one filling mode and an emptying mode. The movement of the wall portions relative to one another provides an advantageous effect during both emptying and filling of said hole of the dosing system. During filling the moving wall portions ensure for a sufficiently treated powder and hence an accurate and reliable dosing of powder is accounted for. Furthermore, emptying as well as discharge of powder from a hole is performed in a reliable and controlled manner making it possible to portion batches of powder with a high accuracy and with low retention of powder.

Suitably, the device is adapted for a particulate material comprising powdered medicament.

Advantageously, the wall portions comprise slidable dosing plates movable relative to one another. More preferably, the wall portions are slidable dosing plates movable relative to one another and substantially perpendicularly to the propagation of the hole. The axial centre line can be looked as representing the propagation of the hole for many types of holes. In accordance with the invention a significantly complex powder pouring operation may be performed in a simple manner and by means of a robust design. By the arrangement of the plates in layers surrounding each hole and said plates being movable in parallel to a substantially perpendicular plane in relation to the hole a reliable and robust function of the powder provider device is accomplished.

Accordingly, the wall structure is formed of a plurality of end portions of the slidable plates and movable relative to one another. The movable wall portions are arranged to a moving member that induces a movement to respective wall portion. The movement is induced individually or to a group of associated wall portions in order to achieve a desired movement pattern. The moving member is adapted to start and stop in accordance with the filling and emptying sequence. The slidable dosing plates are arranged to a moving member that induces individual or mutually associated movement of said slidable dosing plates.

The abutting sides of the neighboring slidable dosing plates are arranged with a narrow fit in relation to the size of the powder particles. Thus, even small powder particles may be kept inside the hole of the hole structure. Furthermore, the exact volume of the hole will be clearly established by using manufacturing methods, materials and shapes having small tolerances. Preferably, the slidable dosing plates are made of any one of a ceramic or metal containing material.

Furthermore, in accordance with a preferred embodiment of the invention the dosing system additionally comprises a lid arrangement and the lid arrangement has openings, which, in a first position, is positionable in register with the holes of the hole structure.

When a sufficient amount of dry powder has been poured into the hole and the hole may be closed. For this purpose the dosing system comprises a lid arrangement.

The lid arrangement has openings, which, in a first position, is positionable in register with the holes of the hole structure. The powder is then introducible into the hole. When the holes have been filled in an intermediate condition the lid arrangement is provided in a closing state. The plates constituting the wall portions of each hole defines a closed volume together with the lid and a closing arrangement. Suitably, the lid arrangement, when emptying of the powder from any one of the holes is due, is positionable in an offset position so as to block the opening of the holes. This is performed in order to prevent additional powder from entering the hole once a dose of powder is in place and thus it is assured that a correct dose of powder is delivered further to the system. In order to enable this the dosing system comprises a lid arrangement which, when emptying of the powder from any one of the holes is due, is positionable in an offset position so as to block the holes. More preferably the lid may be positioned to a hole so as to occupy some space in the hole to a certain degree in order to provide for the correct dose volume during dosing of powder for filling of a medicament cavity.

The dosing system additionally comprises a closing arrangement and the closing arrangement has openings, which, in a first position, is positionable in an offset position so as to block the holes. The dosing system additionally comprises a hole closing arrangement, wherein the hole closing arrangement, when emptying of the powder from any one of the holes is due, is positionable in register with the holes of the hole structure. Thus, introduction of powder as well as release thereof will be smoothly handled and not obstructed by protruding edges, corners, etc.

Suitably, the dosing system, in a preferred powder provider device, is provided with a cavity structure for discharge of the powder from said at least one hole into a corresponding cavity. Preferably, the powder comprises a medicament, such as a drug and/or bioactive agent.

Advantageously, the powder provider device is provided with vibrating means for, during handling of the powder, enabling controlled filling and emptying of the hole in question and further into a corresponding cavity. Alternatively, the powder provider device is provided with an ultrasonic element for, during handling of the powder, enabling controlled filling and emptying of the hole in question and further into a corresponding cavity.

The dosing system in a powder provider device is provided with at least two oscillating movable dosing plates for, during handling of the powder, enabling controlled filling and emptying of the hole in question and further into a corresponding cavity. Preferably, the oscillating movement is accomplished by means of induced movement from the moving member.

In accordance with a second embodiment of the invention the dosing system is arranged turnable into an up side down position for emptying the at least one hole of powder into a corresponding cavity. This is preferable in case the hole/s is/are provided with one opening each.

Preferably, the volume of the hole is smaller than the volume of a corresponding cavity into which powder is to be poured from the hole. The volume of the hole is correlated to the desired amount of powder in the cavity of a cavity structure. Thus, the components of the powder provider itself are used as measuring equipment. For many reasons it is advantageous that the cavity into which the measured dose is poured provides more room than the hole from which said powder was discharged. In case the powder requires more space in the cavity that required space is accounted for without jeopardizing e.g. the measured dose.

According to a preferred embodiment the hole structure comprises several holes, the amount of which is the same as the amount of cavities, and that the positions of the holes correspond to the positions of the cavities in the disc when said disc is arranged to the dosing system. Still more preferably, the cavity structure is provided with 60 cavities in order to provide a sufficient number of doses to last one month. Accordingly, the hole structure comprises several holes, the amount of which correspond to half the amount of the cavities in a disk, and that the position of said holes correspond to the position of every second cavity in the disc when the disc is arranged to the dosing system.

Preferably, the hole structure is provided with 30 holes and the cavity structure in the form of a cavity disc comprises 60 cavities in a non-linear, preferably annular or similar, arrangement. In accordance to a second embodiment of the cavity structure the cavities being arranged in a linear cavity arrangement. Alternatively, the dosing system comprises at least one hole structure provided with said at least one hole, and one cavity provided in a disc.

Accordingly it is realized that a powder provider device in accordance with any of the previously disclosed embodiments can be provided in an apparatus for producing packs containing doses of medicament, the packs comprising at least one cavity for housing a dose of medicament. The apparatus is used for filling a cavity with a quantity of particulate material, and may comprise sealing means for sealing said cavity with a sealing sheet. Such apparatus will improve the handling of powder during filling of powder into cavity structure as well as measuring the correct dose and the handling of powder during that operation.

Furthermore, in accordance with the invention it is presented a method of dosing and providing powder in a powder provider comprising, a hole structure, having at least one hole formed by a surrounding wall structure comprising wall portions, said method comprising the following handling steps: filling of said hole with powder, emptying of said hole and effecting the wall portions, during at least one of said filling and emptying, to move relative to one another, whereby the relative movement of wall portions enabling controlled dosing and pouring of powder. The dosing system has at least one filling mode and an emptying mode. The movement of the wall portions relative to one another provides an advantageous effect during both emptying and filling of said hole of the dosing system. During filling the moving wall portions ensure for a sufficiently treated powder and hence an accurate and reliable dosing of powder is accounted for. Furthermore, emptying as well as discharge of powder from a hole is performed in a reliable and controlled manner making it possible to portion batches of powder with a high accuracy and with low retention of powder. Suitably, the powder handled by the method according to the invention is a particulate material comprising powdered medicament.

Preferably, the method involves the step of moving wall portions relative to one another comprising effecting movement of slidable dosing plates. Advantageously, the wall portions are slidable dosing plates movable relative to one another and substantially perpendicularly to the propagation of the hole. In accordance with the invention a significantly complex powder pouring operation may be performed in a simple manner and by means of a robust design. By the arrangement of the plates surrounding each hole and said plates being movable parallel to one another in a substantially perpendicular plane in relation to the hole a reliable and robust function of the powder provider device is accomplished. Alternatively, the method according involves the step of oscillating at least two movable dosing plates, during at least one of the filling and emptying steps. The oscillating movement is performed or effected by a moving member arranged to said plates.

Accordingly, the wall structure is formed of a plurality of end portions of the slidable plates and movable relative to one another. The movable wall portions are arranged to a moving member that induces a movement to respective wall portion. The movement is induced individually or to a group of associated wall portions in order to achieve a desired movement pattern. The moving member is adapted to start and stop in accordance with the filling and emptying sequence. The slidable dosing plates are arranged to a moving member that induces individual or mutually associated movement of said slidable dosing plates.

Suitably, the preferred method in accordance with the invention comprising the step of moving wall portions comprising effecting movement of slidable dosing plates relative to one another in parallel planes, said planes propagating perpendicularly in relation to the main propagation direction of said hole. More preferably, the abutting sides of the slidable dosing plates being movable with a narrow fit where the distance in between is approximately zero.

In order to facilitate handling and improve reliability during the cavity filling operation the method according to the invention comprising positioning of a lid arrangement in an offset position so as to block the holes of the hole structure, when emptying of the powder from any one of the holes is due. Furthermore, said lid arrangement having openings, which, in a first position, being positionable in register with the holes of the hole structure. The method further involves the step of positioning a closing arrangement in a first position so as to block the holes of the hole structure, when filling of the powder in any one of the holes is due. Preferably, the method comprises the step of positioning a closing arrangement having openings, which, in a second position, being positionable in register with the holes of the hole structure, when emptying of the powder from any one of the holes is due.

In addition to the step of moving the wall portions the method may include discharging the powder from said at least one hole into a corresponding cavity thereof. Another preferred way of further enabling emptying and secure filling operations during handling of powder would be vibrating the dosing system comprising powder containing holes, during at least one of the filling and emptying steps. Alternatively, the method according to the invention may contain providing an ultrasonic effect, during at least one of the filling and emptying steps.

Alternatively the dosing system according to the invention is provided with a deformable wall structure for, during handling of the powder, enabling controlled filling and emptying of the hole in question and further into a corresponding cavity. The moving member may alternatively initiate movement into a flexible material forming the wall of the hole. The movement of the flexible material causes the wall portions of said hole to move and in turn the movement of wall portions relative to one another provides the advantageous effect during both emptying and filling of said hole. During filling the moving wall portions ensure for a sufficiently treated powder and hence an accurate and reliable dosing of powder is accounted for. Furthermore, emptying or discharge of powder from a hole is performed in a reliable and controlled manner making it possible to portion batches of powder with a high accuracy and with low retention of powder. It is realised that the movement pattern of the wall portions may be performed differently during e.g. filling and emptying.

Further, the powder provider device may be provided with a first and a second monitoring unit. The first monitoring unit is arranged to scan the holes to confirm complete filling. The second monitoring unit is arranged to scan the dosing system to confirm complete emptying of the dosing system. The cavity structure can optionally be transferred through or by a third monitoring unit arranged to confirm accurate filling of the cavities in the cavity structure. Furthermore, it is desirable that the sides of the cavity structure intended to bond with the seal (not shown here) are clean in order to ensure for an accurate fit when sealing of the cavities is due. Hence, the powder provider device may be provided with a cleaning unit primarily adapted to sweep off powder from the surfaces to be provided with a seal.

The medicament-containing cavity may contain various drugs and/or bioactive agents. The bioactive agent may be selected from any therapeutic or diagnostic agent. For example it may be from the group of antiallergics, bronchodilators, bronchoconsitrictors, pulmonary lung surfactants, analgesics, antibiotics, leukotrine inhibitors or antagonists, anticholinergics, mast cell inhibitors, antihistamines, antiinflammatories, antineoplastics, anaesthetics, anti-tuberculars, imaging agents, cardiovascular agents, enzymes, steroids, genetic material, viral vectors, antisense agents, proteins, peptides and combinations thereof.

Examples of specific drugs which can be incorporated in the medicament containing cavity according to the invention include mometasone, ipratropium bromide, tiotropium and salts thereof, salemeterol, fluticasone propionate, beclomethasone dipropionate, reproterol, clenbuterol, rofleponide and salts, nedocromil, sodium cromoglycate, flunisolide, budesonide, formoterol fumarate dihydrate, Symbicort™ (budesonide and formoterol), terbutaline, terbutaline sulphate, salbutamol base and sulphate, fenoterol, 3-[2-(4-Hydroxy-2-oxo-3H-1,3-benzothiazol-7-yl)ethylamino]-N-[2-[2-(4-methylphenyl)ethoxy]ethyl]propanesulphonamide, hydrochloride. All of the above compounds can be in free base form or as pharmaceutically acceptable salts as known in the art.

Combinations of drugs may also be employed, for example formoterol/budesonide; formoterol/fluticasone; formoterol/mometasone; salmeterol/fluticasone; formoterol/tiotropiurn salts; zafirlukast/formoterol, zafirlukast/budesonide; montelukast/formoterol; montelukast/budesonide; loratadine/montelukast and loratadine/zafirlukast.

Further combinations include tiotropium and fluticasone, tiotropium and budesonide, tiotropium and mometasone, mometasone and salmeterol, formoterol and rofleponide, salmeterol and budesonide, salmeterol and rofleponide, and tiotropium and rofleponide.

### BRIEF DESCRIPTION OF THE DRAWINGS

The present invention will now be described, for exemplary purposes, in more detail by way of embodiments and with reference to the enclosed drawings, in which:

FIG. 1 is a schematic perspective view of a powder provider device,

FIG. 2 is a cross sectional view of an embodiment of the powder providing device, and an embodiment of the scraper means according to the present invention,

FIG. 3a-3c are partial schematic cross sectional side views disclosing a hole structure illustrating the main steps of a dosing and pouring method according to the present invention,

FIG. 4 is a partial schematic cross sectional side view disclosing a first embodiment of the powder provider device according to the present invention,

FIG. 5a-5b is a partial schematic cross sectional side view disclosing a modification of a first embodiment of the powder provider device according to the present invention,

FIG. 6a-6b is a partial schematic cross sectional side view disclosing a first alternative shape of a hole of a powder provider device in accordance with an embodiment of the invention,

FIG. 7a-7b is a partial schematic cross sectional side view disclosing a second alternative shape of a hole of a powder provider device in accordance with an embodiment of the invention,

FIG. 8a-8b is a partial schematic cross sectional side view disclosing a hole of a powder provider device in accordance with a second embodiment of the invention,

FIG. 9a-9b is a partial schematic cross sectional side view disclosing a hole of a powder provider device in accordance with a third embodiment of the invention,

FIG. 10a-10b is a partial schematic cross sectional side view disclosing a hole of a powder provider device in accordance with an alternative third embodiment of the invention,

FIG. 11 is an exploded perspective view of a first embodiment of a cavity structure according to the present invention, and

FIG. 12 is a perspective view of a second embodiment of a cavity structure according to the present invention.

### DETAILED DESCRIPTION OF THE PREFERRED EMBODIMENTS

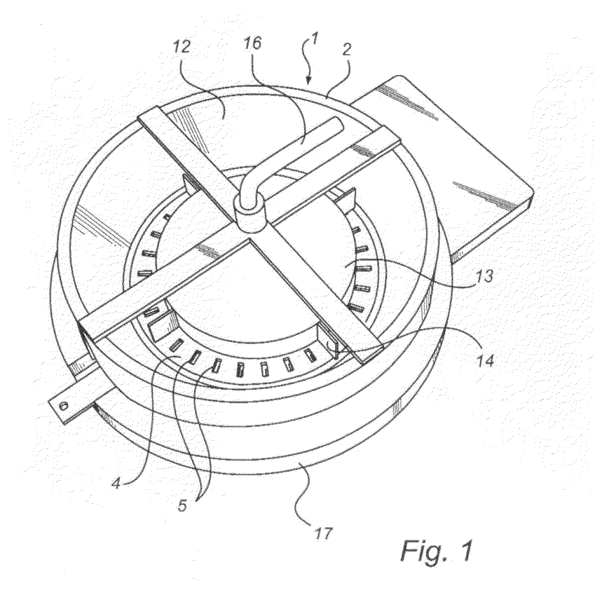

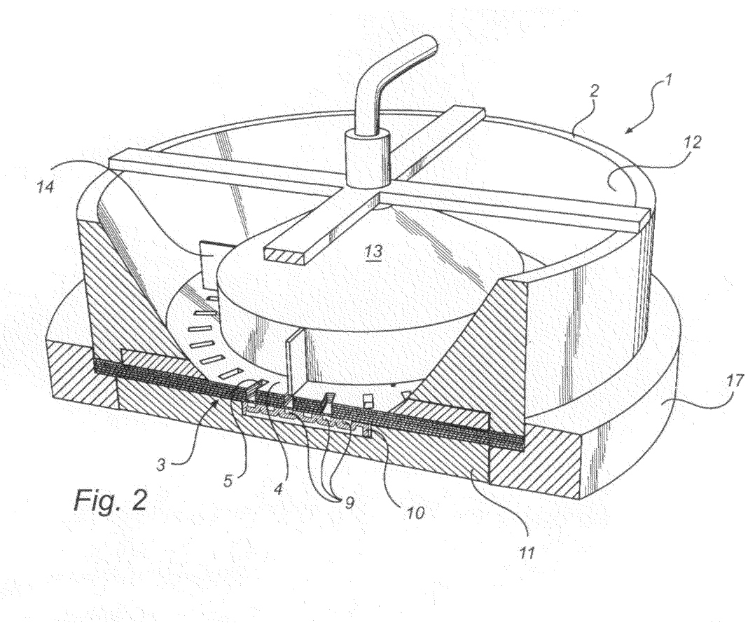

FIGS. 1 and 2 show a powder provider device 1 provided with a powder hopper 2 for housing powdered medicament (not shown). The powder hopper 2 has a funnel shaped interior and the sloping surfaces thereof are intended to guide the powdered medicament (not shown) towards a dosing system 3. The dosing system 3 is formed as a hole structure 4 with holes 5 distributed in a circular pattern. In the middle of the circular pattern of holes 5 a scraper arrangement 13 is rotatably arranged. The upper side of the dosing system 3 can also be seen as forming the bottom of the powder hopper 2. Scraper blades 14 are arranged to said scraper arrangement 13. When the scraper arrangement 13 rotates the scraper blades 14 follow in close relation with the upper side of the dosing system 3. During rotation of the scraper arrangement 13 the scraper blades 14 will shovel powder of the powder funnel 12 into the holes 5 of the hole structure 4. The scraper blades 14 each pass the holes 5 one by one during rotation of the scraper arrangement 13. A driving axis 16 possibly effects the rotation and the scraping will result in filled holes 5, in which each hole 5 having an evenly distributed top nm of powder.

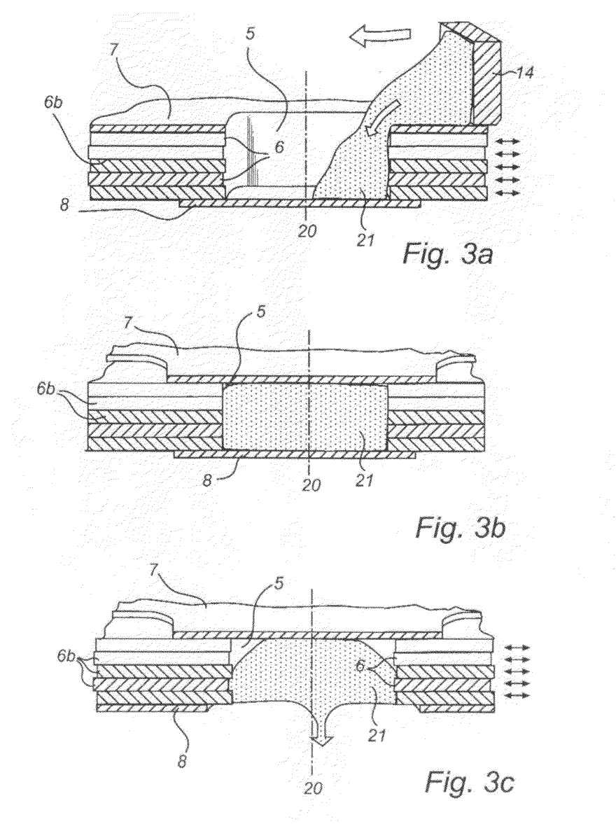

Now, with reference to FIG. 3a-3c a currently preferred method of dosing and pouring powder is disclosed more in detail. In FIG. 3a a section of one hole 5, of a hole structure 4, is outlined schematically. The arrows in FIG. 3a indicate the shovel direction of the scraper blades 14 during movement of the scraper arrangement 13. A second arrow is disclosed for illustrating how the powder 21 is being introduced into a hole 5 of a hole structure 4.

The dosing system 3 additionally comprises a closing arrangement 8. The closing arrangement 8 is conveniently formed as a plate which, in a first position, is positionable so that it will block the holes 5 entry into or out from the hole from that side. The closing arrangement 8 is thus adapted to form a bottom of the holes 5 when in the first position. The blocking of a hole 5 is in effect during filling of the hole 5 as disclosed in FIG. 3a.

When a sufficient amount of dry powder 21 has been poured into the hole 5 it may is be closed. For this purpose the dosing system 3 comprises a lid arrangement 7. The lid arrangement 7 has openings, which, in a first position, is positionable in register with the holes 5 of the hole structure 4. The first position of the lid arrangement openings is disclosed in FIG. 3a illustrating an initial step in the powder providing sequence. During this step the powder is introducible into the hole 5. The wall structure of said holes 5 comprises a plurality of movable wall portions 6. During filling of said hole 5 the wall portions 6 may be moved in relation to one another. The relative movement of the wall portions 6 has proven to enable a reliable filling and an accurate dosing of powder in each hole 5.

Now, continuing to FIG. 3b an intermediate condition of the dosing operation is disclosed. In said intermediate condition the lid arrangement 7 is provided in a closing state and the closing arrangement 8 as well. One side of each dosing element 6b in the form of individually movable plates piled upon each other constitute the wall portions of each hole 5. The wall portions define a closed volume together with the lid and closing arrangement 7, 8. As will be readily appreciated from the cross section of FIG. 3b the hole 5 will be completely filled with powder 21 in this intermediate operation condition.

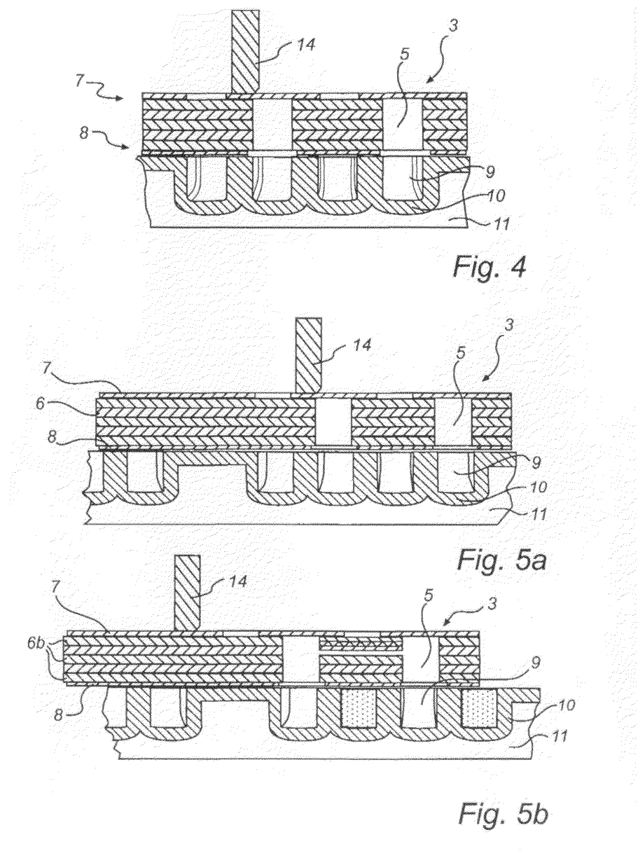

Referring further to FIG. 3c, in which the emptying operation of the hole 5 is illustrated. Sideways of the hole closing arrangement part, which is adapted to form the bottom of anyone of said holes 5, there exist openings with generally the same dimensions as the hole 5 openings. In a second position the openings of the hole closing arrangement 8 are positioned in register with the holes 5 as seen from the side. When an opening of the hole closing arrangement 8 is in a corresponding position to that of a hole 5 the powder may be discharged from said hole 5. The discharge procedure is explained further with reference to FIG. 4.

Suitably the lid arrangement 7, when emptying of the powder from any one of the holes 5 is due, is positionable in an offset position so as to block the opening of the holes 5. This is performed in order to prevent additional powder from entering the hole 5 once a metered dose has been accomplished and thus it is assured that a correct dose of powder is delivered further to the system. In order to further improve correct delivery of powder quantity the wall portions 6 of the hole/holes in questions are moved in relation to one is another. The relative movement of the wall portions 6 has proven to enable a reliable emptying effect and an accurate further dosing of powder with low retention of powder.

Preferably, the relative movement of wall portions in the currently preferred embodiment is accomplished by movement of the plates constituting the hole structure 4. The structure surrounding the hole 5 walls 6 consequently constituting the wall structure for the holes 5. In accordance with the currently preferred embodiment the plates forming said hole structure are slidable back and forth in a direction substantially perpendicular relative to the main propagation direction of the hole in question, which main propagation direction substantially coincides with intended path for the powder. The movement of each plate 6 is conveniently, but not exclusively, in the range between ±2% to ±50% of the diameter of the hole 5 with reference from the aligned start and stop position. Preferably, the plate movement is between ±5% to 25% of the diameter of the hole and more preferably between ±7% to 15% of the diameter of the hole 5. When referring to the diameter of the hole 5 it is submitted that a hole 5 may be formed differently. Hence, the diameter in accordance with the present application should be interpreted in a broad meaning as representing the longest distance across the hole in question, whether it is squared or has another shape that may have different distances between sides thereof.

When the holes 5 of the dosing system 3 are filled the step of discharging the powder from the holes 5 and into respective cavities 9 may take place. FIG. 4 discloses an embodiment of the powder provider device 1 comprising a cavity structure 10, which is adapted to the dosing system 3. The cavity structure 10 is arranged to the lower portion of the dosing system 3. The openings of the cavities 9 are fitted in close relation to the closing arrangements of the dosing system 3. The closing arrangement 8 is movable from a closed condition to an opened condition thus releasing powder from the holes 5 of the dosing system 3. The powder discharge of the holes 5 is further influenced by the back and forth movement of the hole wall portions leading to an emptying of the holes 5. Test results for various powders have indicated a low retention degree when using the method and the device according to the invention. Hence, accurate and reliable dosing operations are feasible.

Now, with reference to FIGS. 5a and 5b a cavity filling operation of a currently preferred embodiment will be explained. The dosing system 3 is provided with several holes 5, the number of holes being half of the number of cavities 9 in said cavity structure 10. The location of the holes 5 corresponds to the location of every second cavity 9 of the cavity structure 10. The opening of each hole 5 is facing an opening of a cavity 9 when the cavity structure 10 is arranged to the dosing system 3.

When a sufficient amount of dry powder has been poured into the hole 5 the hole may be closed. For this purpose the dosing system 3 comprises a lid arrangement 7. The lid arrangement 7 has openings, which, in a first position, is positionable in register with the holes 5 of the hole structure 4. The openings of the closing arrangement 8 are positioned in register with the holes 5 as seen from the side of the powder providing device 1. When an opening of the closing arrangement 8 is in a corresponding position to that of a hole 5 powder may be discharged from said hole. The discharge procedure is explained further with reference to FIG. 4.

Suitably, the lid arrangement 7, when emptying of the powder from any one of the holes is due, is positionable in an offset position so as to block the opening of said holes. This is performed in order to prevent additional powder from entering the hole once a metered dose has been accomplished and thus it is assured that a correct dose of powder is delivered further to the system. In order to enable correct delivery of powder quantity the wall portions 6 of the hole/holes 5 in questions are moved in relation to one another (not shown). Once a first batch of powder has been delivered to the cavities 9 of the cavity structure 10 the cavity structure may be set in a second position. In the second position the cavities 9 not yet filled are positioned in register with the holes 5. The dosing sequence previously described with reference to FIGS. 3a-3c is repeated.

Now, as will be seen in FIG. 5b the remaining cavities will then be provided with powder. Since every second cavity 9 of the cavity structure 10 is filled in the first batch, the positioning of the cavity structure 10 in the second position is now enabling filling of the other cavities 9. The procedure described in association with that of FIG. 5a will be repeated.

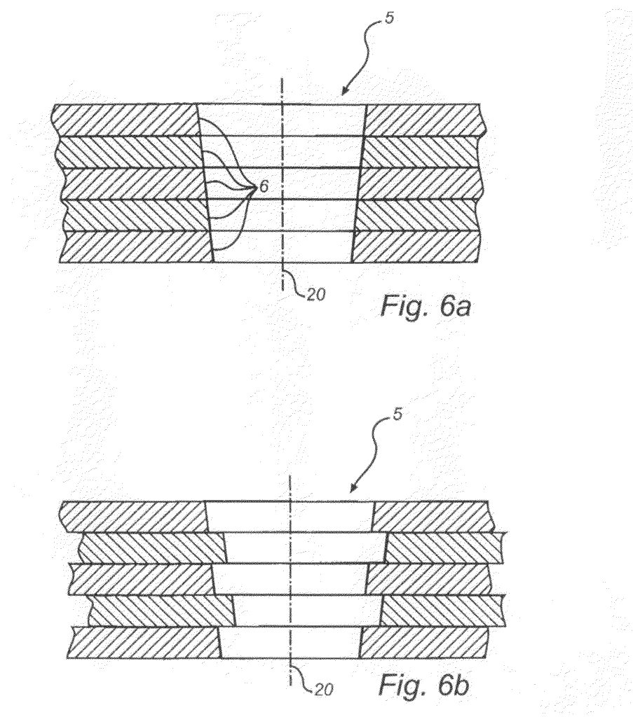

FIGS. 6a and 6b discloses an alternative shape of a hole 5 of a powder provider device. The hole 5 has a conical shape, having a wider top opening than the bottom opening as seen in cross section. Conveniently, the walls form a linear slope from top to bottom when the wall portions are in a resting position and the shape is symmetric around a centre line 20 of said conically shaped hole 5. Consequently, the powder will be guided along the slope while filling and emptying the hole 5.

The wall portions 6 are movable during e.g. emptying and filling as further exemplified in FIG. 6b. The relative movement of the wall portions 6 may be performed in different ways as described previously in the present application. According to the disclosed embodiment the formation of movable wall portions is accomplished by a number of slidable dosing elements 6b (no reference number disclosed in FIGS. 6a, 6b), formed as plates, arranged movable in relation to one another. Suitably, the slidable dosing elements 6b (no reference number disclosed in FIGS. 6a, 6b) are arranged in layers surrounding the hole/s 5. The movement may be controlled so as to perform the desired movement pattern. For some powders it may be suitable to induce shear by inducing rather large movement patterns while others may benefit from smaller and perhaps more rapid movement pattern.

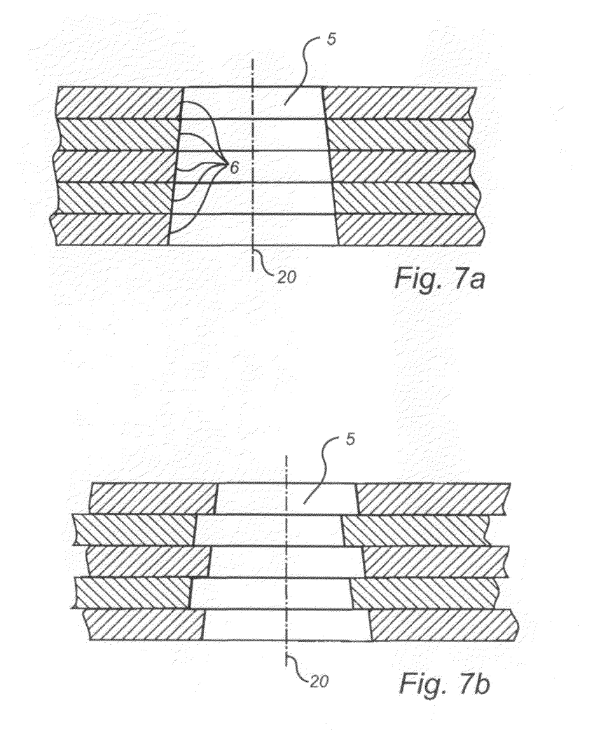

FIGS. 7a and 7b discloses a second alternative shape of a hole 5 of a powder provider device. The hole 5 has a conical shape, having a narrower top opening than the bottom opening as seen in cross section. Conveniently, the walls of the hole are more spaced apart as seen from the side when starting from the top and continuing to the bottom of the hole when the wall portions are in a resting position and its shape is symmetric around a centre line 20 of said conically shaped hole 5. Generally, the powder in such hole will have less contact with the wall portions 6.

The wall portions 6 are movable during e.g. emptying and filling as further exemplified in FIG. 7b. The relative movement of the wall portions 6 may be performed in different ways as described previously in the present application. According to the disclosed embodiment the formation of movable wall portions is accomplished by a number of slidable dosing elements 6b (no reference number in FIGS. 7a, 7b), formed as plates, arranged movable in relation to one another. Suitably, the slidable dosing elements are arranged in layers surrounding the hole/s 5. Thus, it is the end portions of the slidable dosing elements, facing the hole 5, that will form part of the wall of the hole 5. This second alternative embodiment is preferable when retaining of powder due to adherence to the wall of the hole is a particular issue.

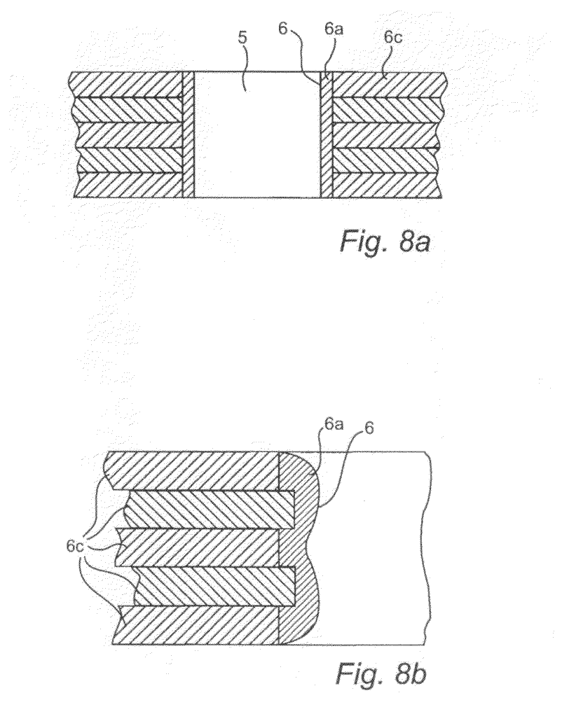

For the disclosed alternative embodiments it is of particular interest that the slidable dosing elements are fitted close to one another in order to avoid undesirable intrusion of particulate medicament powder in between said slidable dosing elements. In order to further improve the resistant against intrusion of powdered medicament a second embodiment comprising the claimed features is disclosed in FIGS. 8a and 8b. According to the disclosed second embodiment the formation of movable wall portions 6 is accomplished by a deformable wall structure made of elastic material. The deformable wall structure 6a is arranged to the slidable dosing elements 6c, formed as plates, arranged movably in relation to one another. Suitably, the slidable dosing elements 6c are arranged in layers surrounding the hole/s 5. Thus, it is the deformable wall portion 6a arranged to the slidable dosing elements 6c, facing the hole 5, that will form part of the wall of the hole 5.

According to an alternative second embodiment of the invention (not disclosed in detail) of which the features are similar to the ones of the present second embodiment and thus not repeated again it is accomplished a deformable wall structure of flexible material. The deformable wall structure is e.g. clamped around the top of the hole. The deformable wall structure continues further down the hole and will be affected by the movement of the surrounding slidable dosing elements or other poking devices adapted for causing movement of the wall portions of the hole.

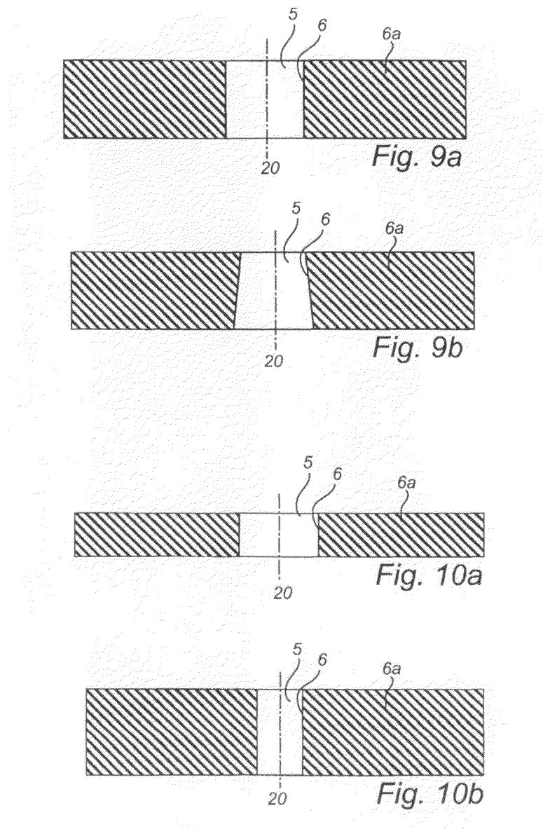

Now, with reference to FIGS. 9a-9b, 10a-10b the characterizing features of a third embodiment of the invention is disclosed schematically. Contrary to the hitherto described embodiments the principle of causing movement of the wall portions 6 of the hole of a third embodiment is not using slidable dosing elements but rather a larger volume of deformable wall structure 6a. When exposed to e.g. bending, shearing, pushing, pressing or similar the deformable wall structure 6a will deform and accordingly the wall portions will move. In the third embodiment disclosed in FIG. 9a the wall portions 6 of the hole 5 is not exposed to any specific forces or induced movement, whereas in FIG. 9b the wall portions are moved due to bending of the deformable wall structure 6a.

In the third embodiment disclosed in FIG. 10a the wall portions 6 of the hole 5 is not exposed to any specific forces or induced movement, whereas in FIG. 10b the wall portions are movable in relation to one another in the vertical direction due to pressing of the deformable wall structure 6a. During this operation the wall of the hole 5 as such is also moved but in a generally horizontal plane.

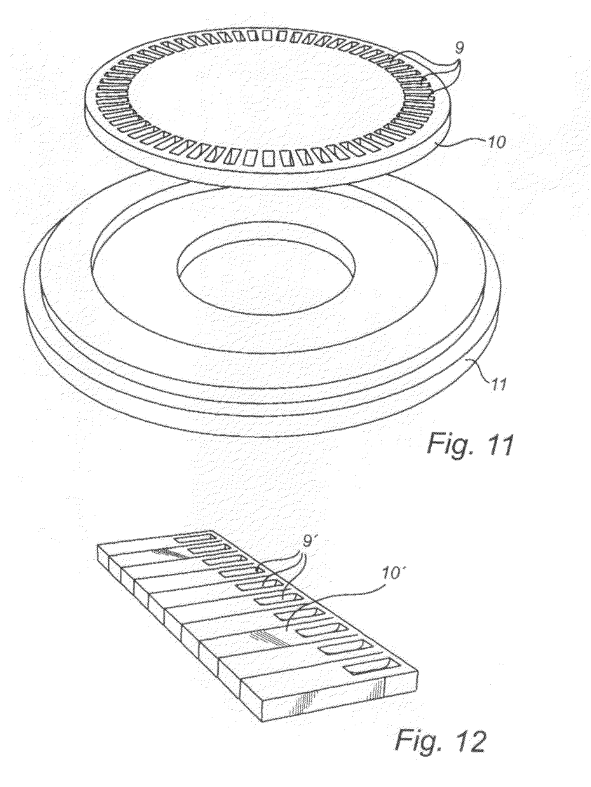

FIG. 11 illustrates a cavity structure 10 which has been formed in accordance with at least one embodiment of the invention and which will be comprised in a medicament-containing structure. The cavity structure 10 is provided with a series of cavities 9 for containing a medicament. The illustrated cavity structure 10 has been formed by injection molding a piece of material, such as a plastic material. Other forming procedures are also conceivable. The cavity structure 10 has the shape of a curved elongate strip. The curvature can be considered to define an inner perimeter and an outer perimeter along the length of the cavity structure 10. The medicament-containing structure comprising the cavity structure 10 and is placed in a cavity structure holder 11.

It should be understood that the alternatives, which have been illustrated above, are just some examples. Other shaped cavity structures 10 may also be conceivable to subsequently obtain a desired user-ready shape of the base. Furthermore, the user-ready shape does not necessarily have to be circular, or even annular, wherefore another example is illustrated in FIG. 12.

FIG. 12 illustrates that the cavity structure 10′ has been bent from the curved shape illustrated in FIG. 6 into a linear or straight shape. In this state, the central geometrical axes of the projecting sections extend substantially parallel to each other.

Further, the powder provider device 1 may be provided with a first and a second monitoring unit. The first monitoring unit is arranged to scan the cavities to confirm complete filling. The second monitoring unit is arranged to scan the dosing system to confirm complete cleaning of the dosing system 3. The cavity structure 10 can optionally be transferred through or by a third monitoring unit arranged to confirm accurate filling of the cavities 9 in the cavity structure 10. Furthermore, it is desirable that the sides of the cavity structure 10 intended to bond with the seal (not shown here) are clean in order to ensure for an accurate fit when sealing of the cavities 9 is due. Hence, the powder provider device 1 may be provided with a cleaning unit primarily adapted to sweep off powder from the surfaces to be provided with a seal.

It should be understood that the alternatives, which have been illustrated above, are just some examples, and that other alternatives are also possible in order to achieve a desired effect of cavity filling with a low retention degree in the dosing system. Also, in the illustrated examples, it is shown to move wall portions during filling and emptying in order to control the procedure and improve the accuracy in the dosing. During filling the moving wall portions ensure for a sufficiently treated powder and hence an accurate and reliable dosing of powder is accounted for. Furthermore, emptying or discharge of powder from a hole is performed in a reliable and controlled manner making it possible to portion batches of powder with a high accuracy and with low retention of powder. It is realised that the features of the above presented embodiments is not a complete description of all aspects of the invention and further combinations of features from different embodiments are conceivable within the claimed scope of protection. Hence, it is possible to combine various features with different embodiments within the claimed scope for enabling further aspects of the invention.

1. A powder provider device, comprising
a powder hopper for pouring powder to a
a dosing system that comprises a hole structure, wherein at least one hole is formed by a surrounding wall structure,
wherein said wall structure is formed by wall portions that are movable relative to one another, whereby the relative movement of wall portions, during handling of the powder, enables controlled dosing and pouring of the powder.

2. A powder provider device according to claim 1, wherein the wall portions comprise slidable dosing elements that are movable relative to one another.

3. A powder provider device (1) according to claim 1, wherein the wall portions comprise slidable dosing elements movable relative to one another substantially perpendicularly to the propagation of the hole.

4. A powder provider device according to claim 2, wherein the abutting sides of the neighboring slidable dosing elements are arranged with a narrow fit in relation to the size of the powder particles.

5. (canceled)

6. A powder provider device according to claim 1, wherein the dosing system additionally comprises a lid arrangement and the lid arrangement has openings, which, in a first position, is positionable in register with the holes of the hole structure.

7. A powder provider device according to claim 1, wherein the dosing system additionally comprises a lid arrangement and the lid arrangement, when emptying of the powder from any one of the holes is due, is positionable in an offset position so as to block said holes.

8. A powder provider device according to claim 1, wherein the dosing system additionally comprises a closing arrangement and the closing arrangement has openings which, in a first position, is positionable in an offset position so as to block said holes.

9. A powder provider device according to claim 1, wherein the dosing system additionally comprises a hole closing arrangement, wherein the hole closing arrangement, when emptying of the powder from any one of the holes is due, is positionable in register with the holes of the hole structure.

10. A powder provider device according to claim 1, provided with a cavity structure for discharge of the powder from said at least one hole into a corresponding cavity.

11. A powder provider device according to claim 1, wherein the powder provider device is provided with vibrating means for, during handling of the powder, enabling controlled filling and emptying of the hole in question and further into a corresponding cavity.

12. A powder provider device according to claim 1, wherein the powder provider device is provided with an ultrasonic element for, during handling of the powder, enabling controlled filling and emptying of the hole in question and further into a corresponding cavity.

13. A powder provider device according to claim 1, wherein the dosing system is provided with at least two oscillating movable dosing plates for, during handling of the powder, enabling controlled filling and emptying of the hole in question and further into a corresponding cavity.

14. A powder provider device according to claim 1, wherein the hole structure is provided with a deformable wall structure forming the wall portions of at least one hole thereof.

15. A powder provider device according to claim 14, wherein said deformable wall structure is arranged to be effected by the relative movement of a plurality of dosing elements so as to induce a relative movement of the wall portions of said at least one hole.

16-19. (canceled)

20. A powder provider device according to claim 1, wherein the device is adapted for a particulate material comprising powdered medicament.

21. (canceled)

22. A powder provider device according to claim 1, wherein the wall structure of the hole is formed of a plurality of end portions of slidable plates movable relative to one another.

23. A powder provider device according to claim 1, wherein the wall portions are independently movable in relation to one another.

24. (canceled)

25. A method of dosing and providing powder in a powder provider, the powder provider comprising
a hole structure, having at least one hole formed by a surrounding wall structure comprising wall portions,
said method comprising the following handling steps:
filling of said hole with powder,
emptying of said hole and
effecting the wall portions, during at least one of said filling and emptying, to move relative to one another, whereby the relative movement of wall portions enabling controlled dosing and pouring of powder.

26. The method according to claim 25, in which the step of moving wall portions relative to one another comprising effecting movement of slidable dosing elements.

27. The method according to claim 25, in which the step of moving wall portions comprises effecting movement of slidable dosing elements relative to one another in parallel planes, said planes propagating perpendicularly in relation to the main propagation direction of said hole.

28-36. (canceled)

37. The method according to claim 25, comprising the step of oscillating at least two movable dosing plates, during at least one of the filling and emptying steps.

38-40. (canceled)
